(19) United States
(12) Patent Application Publication
(10) Pub. No.: US 2009/0307175 A1
(43) Pub. Date: Dec. 10, 2009

(54) PARALLEL PATTERN MATCHING ON MULTIPLE INPUT STREAMS IN A DATA PROCESSING SYSTEM

(75) Inventors: Iorio Francesco, Dublin (IE); Jan Van Lunteren, Gattikon (CH)

Correspondence Address: Cantor Colburn LLP-IBM Europe, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/136,386

(22) Filed: Jun. 10, 2008

(51) Int. Cl. G06N 5/02

(52) U.S. Cl. 706/48

(57) ABSTRACT

A method, system and computer program product for performing pattern matching in parallel for a plurality of input streams. The method includes calculating a memory address in a translation table responsive to a current input value, a current state and current state information. A transition rule is retrieved from the transition rule table at the memory address, the transition rule including a test input value, a test current state, and next state information. It is determined if the current input value and the current state match the test input value and the test current state. The current state information is updated with the next state information in response to determining that the current input value and the current state match the test input value and the test current state. The current state information is updated with contents of a default transition rule in response to determining that the current input value and the current state do not match the test input value and the test current state.

### BACKGROUND

This disclosure relates generally to pattern matching in a data processing system, and in particular to parallel data matching on multiple input streams in a data processing system.

Pattern matching functions may be utilized for intrusion detection and virus scanning applications. Many pattern matching algorithms are based on finite state machines (FSMs). A FSM is a model of behavior composed of states, transitions, and actions. A state stores information about the past, i.e., it reflects the input changes from the start to the present moment. A transition indicates a state change and is described by a condition that would need to be fulfilled to enable the transition. An action is a description of an activity that is to be performed at a given moment. A specific input action is executed when certain input conditions are fulfilled at a given present state. For example, a FSM can provide a specific output (e.g., a string of binary characters) as an input action.

A hash table is a data structure that can be used to associate keys with values: in a hash table lookup operation the corresponding value is searched for a given search key. For example, a person's phone number in a telephone book could be found via a hash table search, where the person's name serves as the search key and the person's phone number as the value. Caches, associative arrays, and sets are often implemented using hash tables. Hash tables are very common in data processing and implemented in many software applications and many data processing hardware implementations.

Hash tables are typically implemented using arrays, where a hash function determines the array index for a given key. The key and the value (or a pointer to their location in a computer memory) associated to the key is then stored in the array entry with this array index. This array index is called the hash index. In the case that different keys are associated to different values but those different keys have the same hash index, this collision is resolved by an additional search operation (e.g., using chaining) and/or by probing.

A balanced routing table search (BaRT) FSM (B-FSM) is a programmable state machine, suitable for implementation in hardware and software. A B-FSM is able to process wide input vectors and generate wide output vectors in combination with high performance and storage efficiency. B-FSM technology may be utilized for pattern-matching for intrusion detection and other related applications. The B-FSM employs a special hash function, referred to as “BaRT”, to select in each cycle one state transition out of multiple possible transitions in order to determine the next state and to generate an output vector. More details about the operation of a B-FSM is described in a paper authored by one of the inventors: Jan van Lunteren, “High-Performance Pattern-Matching for Intrusion Detection”, Proceedings of IEEE INFOCOM '06, Barcelona, Spain, April 2006.

In parallel FSM implementations utilized to perform pattern matching functions, several essential processing steps, such as branches and memory accesses, depend on multiple independent input streams and therefore typically can only be performed in a serial fashion. Because of this serial requirement, pattern matching (using, e.g., a B-FSM) cannot efficiently exploit single instruction stream multiple data stream (SIMD) techniques to increase the speed of pattern matching functions.

### SUMMARY

A method of pattern matching in a data processing system is performed in parallel for a plurality of input streams. The method includes calculating a memory address in a translation table responsive to a current input value, a current state and current state information. A transition rule is retrieved from the transition rule table at the memory address, the transition rule including a test input value, a test current state, and next state information. It is determined if the current input value and the current state match the test input value and the test current state. The current state information is updated with the next state information in response to determining that the current input value and the current state match the test input value and the test current state. The current state information is updated with contents of a default transition rule in response to determining that the current input value and the current state do not match the test input value and the test current state.

A system for pattern matching is also provided. The system includes a transition rule table for storing transition rules, a plurality of state registers storing current states of a plurality of state machines, an address generator, a mechanism and a rule selector. The address generator includes circuitry for receiving input current input values and for generating addresses corresponding to transition rules in response to the current input values and the current states. The mechanism operates in parallel on multiple generated addresses for retrieving transition rules corresponding to each of the generated addresses, the retrieving from the transition rule table. The rule selector updates the current states in response to the retrieved transition rules.

A computer program product is also provided for pattern matching in a data processing system. The computer program product include a tangible storage medium readable by a processing circuit and storing instructions for execution by the processing circuit for performing a method in parallel for a plurality of input streams. The method includes calculating a memory address in a translation table responsive to a current input value, a current state and current state information. A transition rule is retrieved from the transition rule table at the memory address, the transition rule including a test input value, a test current state, and next state information. It is determined if the current input value and the current state match the test input value and the test current state. The current state information is updated with the next state information in response to determining that the current input value and the current state match the test input value and the test current state. The current state information is updated with contents of a default transition rule in response to determining that the current input value and the current state do not match the test input value and the test current state.

### BRIEF DESCRIPTION OF FIGURES

FIG. 1 is a block diagram of a B-FSM that may be implemented by an embodiment of the present invention;

FIG. 2 is a transition rule vector that may be implemented by an embodiment of the present invention;

FIG. 3 is a listing of exemplary code that may be implemented by an embodiment of the present invention;

FIG. 4 is a process flow that may be implemented by an embodiment of the present invention;

FIG. 5 is a block diagram of a vector mapping of a transition rule memory table that may be implemented by an embodiment of the present invention;

FIG. 6 is a block diagram of a vector mapping of a default table that may be implemented by an embodiment of the present invention; and

FIG. 7 is a process flow that may be implemented by an embodiment of the present invention to provide full vectorization of all processing steps in a parallel B-FSM implementation.

### DETAILED DESCRIPTION

An exemplary embodiment of the present invention is a parallel B-FSM implementation that provides full vectorization of all processing steps, including the memory accesses.

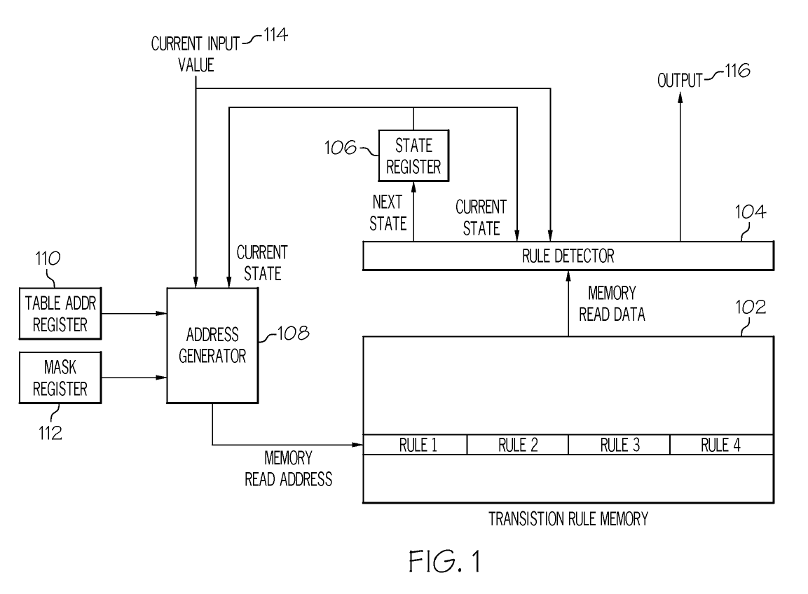

FIG. 1 depicts a block diagram of a subsystem of a B-FSM that may be implemented by an embodiment of the present invention. The B-FSM is a fast programmable state machine originally designed for hardware implementation. The hash index (i.e., the BaRT hash index) is generated by an address generator 108 from a current input value 114 and values in a state register 106 under control of a mask vector stored in a mask register 112. This index is added to the start address of the current hash table (e.g., the start address of the transition rule memory 102) which is stored in the table address register 110 to obtain a memory address that will be used to access the transition rule memory 102. Contents of the transition rule memory 102 are referred to collectively herein as a transition rule table. A total of “N” transition rules are retrieved from the accessed memory location in the transition rule memory 102, with N being an implementation parameter, typically in the range between one and eight (N has a value of four in FIG. 1). The test portions of the N transition rules are evaluated and tested in parallel against the current input value 114 and the state register 106 by the rule selector 104. The highest priority transition rule that is found to be matching is then used to update the state register 106 with a new state value and to generate an output vector 116.

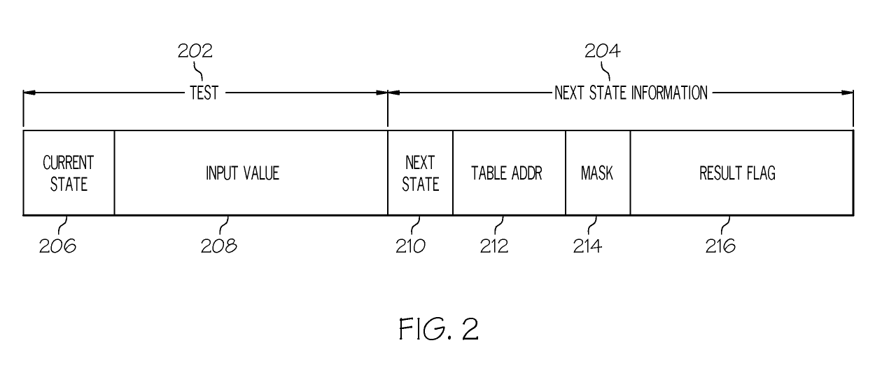

At the core of the B-FSM technology is the concept of specifying state transitions using transition rules. As depicted in FIG. 2, an exemplary transition rule vector format includes a test part 202 and a next state information part 204. The test part 202 includes exact match and/or wildcard conditions for a test current state 206 and test input value 208. The next state information part 204 includes a next state 210, a table address 212, a mask 214, and a result flag 216. The test current state 206 and the test input value 208 are compared to an actual current state and current input value of the sate machine to determine if the transition rule is a match (i.e., should the data in the next state information part 204 of the transition rule be utilized to determine the next state.) The table address 212 indicates the base address of the transition rule table to be utilized by the next state 210. The next state mask 214 is utilized to select a transition rule out of multiple transition rules that may be located at the same address. The result flag 216 is set to indicate that a transition is made to a state for which next state information is defined in a transition rule in the transition rule table (i.e., that the test current state 206 and test input value 208 match the current state and input value respectively). The setting of the result flag 216 indicates that the next state corresponds to the detection of a pattern in the input stream. The B-FSM concept described above can be optimized in various ways. One such optimization is the use of a default rule table, which is described in more detail in the above referenced IEEE INFOCOM '06 paper.

An exemplary embodiment of the present invention allows the basic B-FSM concept to be implemented in a vectorized fashion, thus allowing a simultaneous pattern matching operation on multiple streams in parallel. In an exemplary embodiment these concepts are implemented in software executed on a vector processing unit or synergistic processing element (SPE) within a cell processor. In an exemplary embodiment, multiple state machines may be executing completely independently from each other, by exploiting the SIMD capabilities of the SPE. In particular, the ability to perform multiple (e.g., sixteen) independent accesses to the register “memory” in parallel is exploited, thus providing the ability to simultaneously determine the next states of all state machines for the current sixteen (or other number) input values to the state machines. Thus, full vectorization of all processing steps, including the memory accesses, is achieved in a parallel B-FSM implementation.

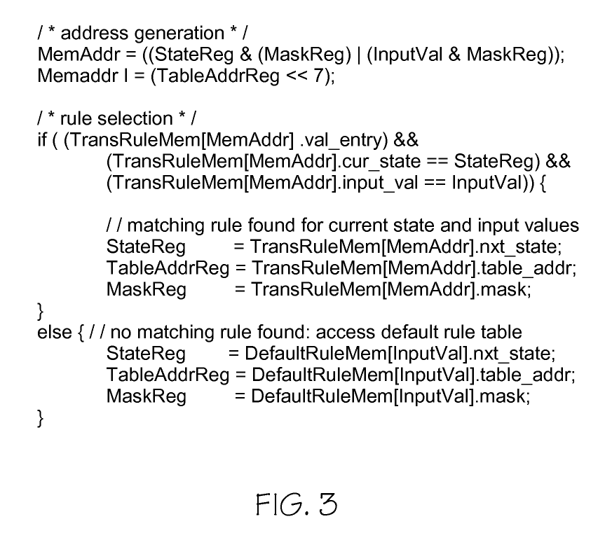

An exemplary basic B-FSM operation cycle for a configuration with N=1 rule per hash table entry is described by the C-code in FIG. 3. In the example depicted in FIG. 3, the state vector is contained in the StateReg variable, the input value is contained in the InputVal variable, the index mask is contained in the MaskReg variable, and the table address is contained in the TableAddrReg variable. The transition rule memory 102 is represented by an array TransRuleMem and is indexed by the calculated memory address. A default rule table is represented by an array DefaultRuleMem and is accessed based on the input value.

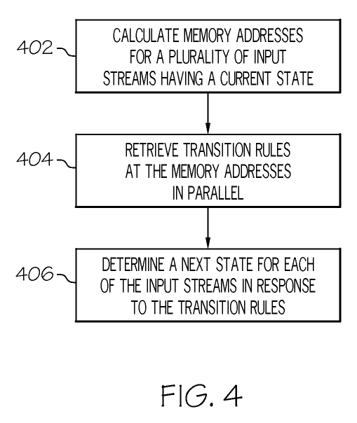

FIG. 4 is a process flow that may be implemented by the code depicted in FIG. 3. In an exemplary embodiment, multiple B-FSMs execute these steps in parallel to each other. At block 402, a memory address is calculated (see address generation portion of the code) by performing a hash function comprised of bitwise (N)AND and OR operations on the current state and input value. In addition, current state information, such as a current mask and a current table address are utilized in the memory address calculation. In an exemplary embodiment, the memory address is calculated for a plurality of input streams in a parallel fashion. At block 404, the calculated memory address is used to access the transition rule memory to retrieve a transition rule vector. Block 404 is performed in parallel for a plurality of input streams. At block 406, the test current state 206 and test current input value 208 from the transition rule vector (“cur_state” and “input_val”) are compared to the actual current values of the state and input (see rule selection portion of the code). If both match, then a matching rule is found and the next state (“nxt_state”), next table address (“table_addr”) and next mask (“mask”) fields of the matching transition rule are used to update the corresponding values. If there is not a match then the new values of the next state, next table address and next mask variables are retrieved by performing a lookup in a default rule memory using the input value. In an exemplary embodiment, block 406 is performed for a plurality of input streams in a parallel fashion.

The first and third steps (blocks 402 and 406) can be vectorized, for example, by mapping multiple eight-bit state, input and mask vectors corresponding to multiple B-FSMs processing separate input streams on the same register set (e.g., 128 bit registers) and performing the required bit wise operations in parallel on these multiple eight bit vectors stored in these registers using few instructions.

An aspect of an embodiment of the present invention is that the second step (block 404), which involves access to the transition rule memory table is also vectorized, providing the ability to perform the accesses to the transition rule memories for the B-FSMs operating on separate input streams entirely in parallel, leading to higher processing rates. This may be achieved by storing the transition rules tables in the register sets of SPEs, and by performing a special indexing of these registers for a total of sixteen independent B-FSMs which operate on different input streams.

In order to vectorize the transition rule table, it must fit in the registers. As a result, this approach can directly be applied to relatively small pattern sets, for which the compiled B-FSM structures fit entirely in the SPE register sets. Furthermore, it can be also be applied on a subset of the total data structure (e.g., the state diagram levels nearest to the initial state) that fits into the register set, while the next level in the memory hierarchy (i.e., the SPE local store) will only be accessed when the B-FSM can't locate a matching rule in the data structure portion contained in the register set. An alternate exemplary embodiment limits the size of the executed state diagrams to a maximum of a few thousand B-FSM transition rules, for which the corresponding data structures fit entirely into the SPE register sets.

An exemplary embodiment executes on a SPE that contains a total of 128 vector registers, each 128 bits wide, corresponding to a total of two kilobytes (KB) of storage. In this embodiment, eighty of these registers are utilized to store one default rule table and two transition-rule tables, which can contain a maximum of 384 (three times 128) transition rules. In the embodiment described herein, the table address field is a single bit, but other bit sizes may also be implemented.

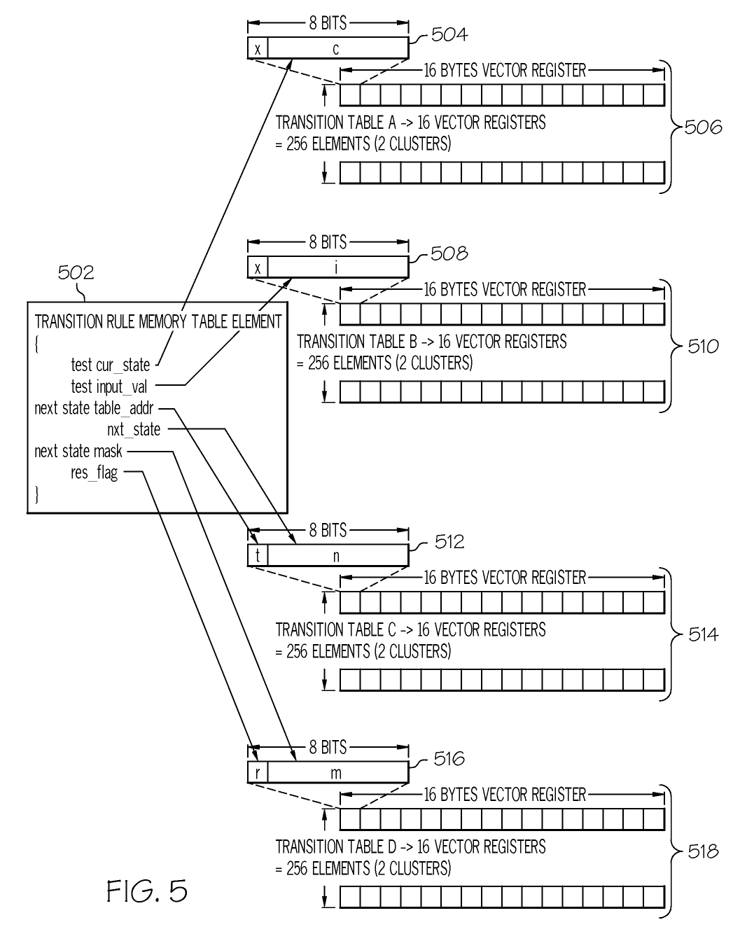

FIG. 5 is a block diagram of a vector mapping of a transition rule memory table that may be implemented by an embodiment of the present invention. In the following example (and as described in reference to FIG. 2), each transition rule vector, or transition rule memory table element 502, includes six fields. Instead of storing the transition rules as an “array of structures”, they are stored as a “structure of arrays” as illustrated in FIG. 5. Each test current state 206 in the transition rule table is stored in one byte 504 in a group of sixteen byte vector registers 506. In the exemplary embodiment depicted in FIG. 5, the group of sixteen byte vector registers 506 includes a block of sixteen consecutive vector registers used to store up to 256 test current state fields from up to 256 transition rules in the two transition-rule tables. The “x” in 504 represents an unused bit location, as the test current state field is a 7-bit value, and thus, the most significant bit of the byte field is unused. Also as depicted in FIG. 5, test input value 208 in the transition rule table is stored in one byte 508 in a group of sixteen byte vector registers 510. In the exemplary embodiment depicted in FIG. 5, the group of sixteen byte vector registers 510 includes a block of sixteen consecutive vector registers used to store up to 256 test input value fields from up to 256 transition rules in the two transition-rule tables. The “x” in 508 represents an unused bit location, as the test input value field is a 7-bit value, and thus, the most significant bit of the byte field is unused.

Still referring to FIG. 5, each next state table address 212 and corresponding next state 210 are stored in one byte 512 in a group of sixteen byte vector registers 514. In the exemplary embodiment depicted in FIG. 5, the group of sixteen byte vector registers 514 includes a block of sixteen consecutive vector registers used to store up to 256 next state table address and next state fields from up to 256 transition rules in the two transition-rule tables. In addition, each next state mask 214 and corresponding result flag 216 are stored in one byte 516 in a group of sixteen byte vector registers 518. In the exemplary embodiment depicted in FIG. 5, the group of sixteen byte vector registers 518 includes a block of sixteen consecutive vector registers used to store up to 256 next state table address and next state fields from up to 256 transition rules in the two transition-rule tables. In this manner, a total of sixty four vector registers are used for storing the two transition rule tables.

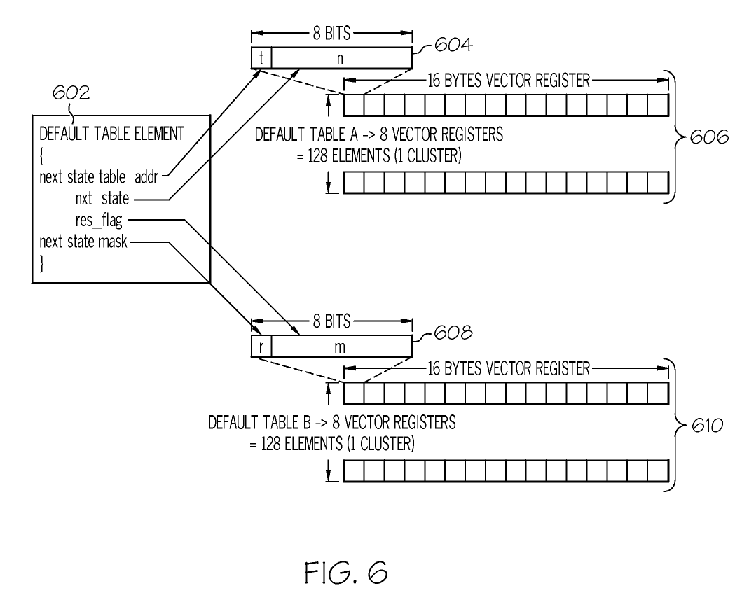

As depicted in FIG. 6, a default transition rule table is mapped in a similar manner. FIG. 6 is a block diagram of a vector mapping of a default transition rule table that may be implemented by an embodiment of the present invention. In an exemplary embodiment, each default table element 602 includes four fields which can be combined into two packed fields so that the 128 default table entries are mapped onto two blocks of eight vector registers. The four fields include a next table address field, a next state field, a result flag field and a next state mask field. Each byte 604 in the first block of vector registers 606 may store a next table address and a next state. Each byte 608 in the second block of vector registers 610 may store a result flag and a next state mask.

The register configuration depicted in FIGS. 5 and 6 are examples and other configurations are possible without departing from the scope of the present invention. For example, a different number of registers may be used to store the different fields in a transition rule table element. An additional example is that a subset and/or additional fields may be included in a transition rule memory table element. Further, the fields may be combined differently and there may be more or less than four groupings. In a further embodiment, the data in one or more of the fields that make up a table element are stored in a compressed format. In another embodiment, there is only one transition rule table. In yet another embodiment, there are more than two transition rule tables and more than one default transition rule table. In another embodiment, more or less than sixteen state machines are generating input streams for parallel processing.

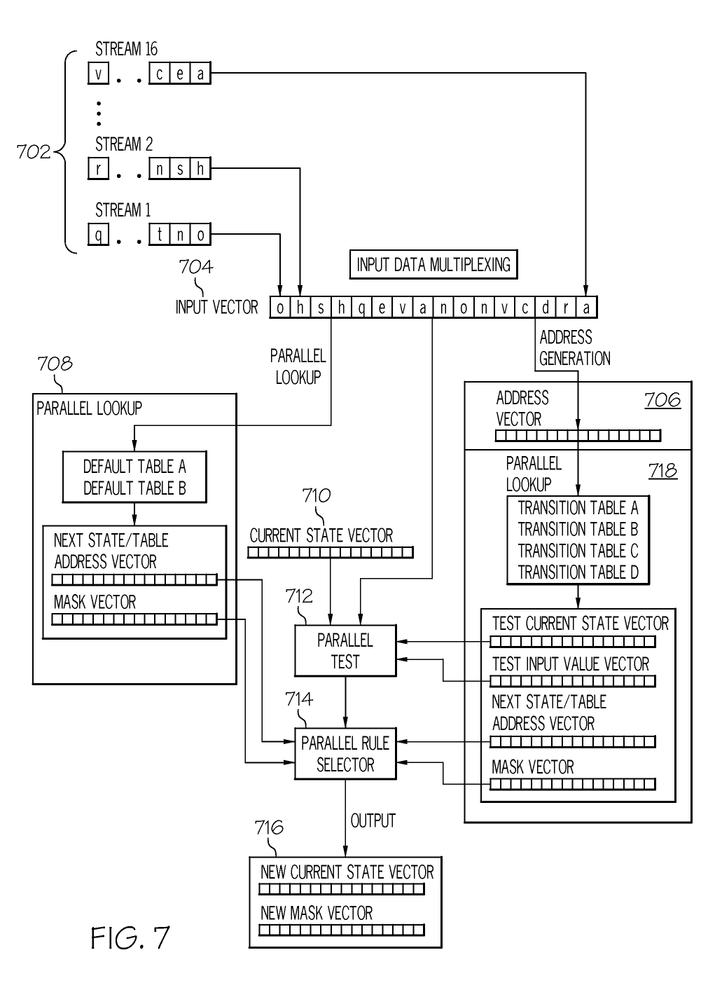

FIG. 7 is a process flow that may be implemented by an embodiment of the present invention. Data input values from multiple input streams 702 are multiplexed together into an input vector 704. The input vector 704 is input to address generation 706 were an address is generated for each of the input streams based, for example, on the current input value from the input stream, a current state of a state machine associated with the input stream, and current state information. In an exemplary embodiment, current state information includes a current table address, and a current mask value. The address of the transition rules is generated and stored in an address vector.

Parallel lookup 718 of the transition rules associated with each input stream is performed using contents of the address vector as input. In an exemplary embodiment, the transition rule memory table is stored in four groups of vector registers as depicted in FIG. 5, and a transition rule associated with each of the input streams is retrieved at the same time (in parallel) as the transition rules associated with the other input streams are being retrieved. The results of the parallel lookup 718 are stored in a test current state vector, a test input value vector, a next state/table address vector and a mask vector. The current state vector and test input value vector are input to the parallel test 712. The next state/table address vector and mask vector are input to the parallel rule selector 714.

An exemplary embodiment of a method for implementing the parallel retrieval follows. The following method is intended to represent one manner of implementing parallel retrieval and other methods may be implemented by embodiments of the present invention depending on specific implementation requirements. In an exemplary embodiment the following specific vector functions are used to operate the parallel retrieval.

Vector and(vector in, int value): every element of the output vector is calculated by a logical ‘and’ operation between the corresponding element in the input vector (first input parameter) and the input value (second function parameter).

Vector cmpeq(vector in, int value): every element of the output vector is set to 0xFF if the corresponding element in the input vector (first input parameter) and the input value (second function parameter) are equal, otherwise it is set at 0x00.

Vector cmpgt(vector in, int value): every element of the output vector is set to 0xFF if the corresponding element in the input vector (first input parameter) is larger than the input value (second function parameter), otherwise it is set at 0x00.

Vector select(vector in_a, vector in_b, vector in_mask): every bit of the output vector is set to the value of the corresponding bit of the second input vector (second input parameter) if the corresponding bit in the input mask vector (third input parameter) is set, otherwise it is set to the value of the corresponding bit of the first input vector (first input parameter).

Vector permute(vector in_a, vector in_b, vector in_mask): input vectors a (first input parameter) and b (second input parameter) are concatenated to form a single larger vector. Every element of the output vector is set to the value of the element of the concatenated vector addressed by the rightmost 5 bits of the corresponding element in the mask vector (third input parameter).

An example of the procedure used to perform the parallel retrieval of 16 values out of a table containing 128 values (8 vector registers), given an input vector containing 16 addresses follows: address_vector is the address vector; the intermediate_0_1, intermediate_2_3, intermediate_4_5, intermediate_6_7, intermediate_0_3, intermediate_4_7, address_bits_0_4, bit_6_mask, bit_7_mask are intermediate variables (registers) used to store the results of the vector functions; and the output_vector is the vector containing the results of the parallel retrieval. Further: address_bits_0_4=and (address_vector, 0x1F); intermediate_0_1=permute(table_vector_0, table_vector_1, address_bits_0_4); intermediate_2_3=permute(table_vector_2, table_vector_3, address_bits_0_4); intermediate_4_5=permute(table_vector_4, table_vector_5, address_bits_0_4); intermediate_6_7=permute(table_vector_6, table_vector_7, address_bits_0_4); bit_6_mask=cmpeq(and(address_vector, 0x20), 0x20); intermediate_0_3=select(intermediate_0_1, intermediate_2_3, bit_6_mask); intermediate_4_7=select(intermediate_4_5, intermediate_6_7, bit_6_mask); bit_7_mask=cmpgt(address_vector, 0x3F); and output_vector=select(intermediate_0_3, intermediate_4_7, bit_7 mask).

In an alternate embodiment for performing parallel retrieval, the following vector instructions are utilized:

Vector add(vector in1, vector in2): every element of the output vector is calculated by integer addition of the corresponding element in the input vector in1 (first input parameter) and the corresponding element in the input vector in2 (second function parameter).

Vector unpack_low(vector in): every 16-bit element in the output vector is set to the value of the equally indexed 8-bit element of the input vector in. No sign extension is provided.

Vector unpack_hi(vector in): input vector in is first rotated by an amount of elements corresponding to half of its size in elements, then every 16-bit element in the output vector is set to the value of the 8-bit element of the input vector in. No sign extension is provided.

Vector pack(vector in1, vector in2): input vectors in1 (first input parameter) and in2 (second input parameter) are virtually concatenated into a large vector; then every 8-bit element of the output vector is set to the truncated 8-bit value of the corresponding 16-bit element in the concatenated vector.

Vector gather(vector address): for every 16-bit element in the output vector, the register file is accessed at the 16-bit addresses contained in the address vector to load the corresponding values.

An example of a procedure that may be utilized to perform the parallel retrieval of 16 values out of a table containing 256 values (16 vector registers), given an input vector containing 16 addresses, and a vector processor with more than 8 read ports on the register file follows. Address_vector is the address vector; table_address_vector is the address of the required table in the register file address space; the table_address_low, table_address_high, address_low, address_high, data_low, data_high are intermediate variables (registers) used to store the results of the vector functions; and the output_vector is the vector containing the results of the parallel retrieval. Further: table_address_low=unpack_low(table_address_vector); table_address_high=unpack_high(table_address_vector); address_low=unpack_low(address); address_high=unpack high(address); address_low=add(address_low, table_address_low); address_high=add(address_high, table_address_high); data_low=gather(address_low); data_high=gather(address_high); and output_vector=pack(data_low, data_high).

In further alternate embodiment, the following vector instructions are required:

Vector gather(vector base, vector offset): for every element in the output vector, an address is first calculated by combining the corresponding element of the input vector base (first input parameter) and the input vector offset (second input parameter) using the formula (base <<8) |offset; then the register file is accessed at the generated addresses to load the corresponding values.

An example of the procedure used to perform the parallel retrieval of 16 values out of a table containing 256 values (16 vector registers), given an input vector containing 16 addresses, a table which address is aligned to 256 bytes in register file address space, and a vector processor with more than 16 read ports on the register file follows: address_vector is the address vector; table_address_vector is the vector containing in each element the address of the required table in register file address space divided by 256, and the output_vector is the vector containing the results of the parallel retrieval. Further: output_vector=gather(table_address_vector, address_vector).

For each of the input streams, during parallel test 712, the test current state and the test input value contained in the corresponding retrieved transition rule is compared to the corresponding current state stored in the current state vector 710 and the corresponding current input value stored in the input vector 704. The results of this comparison are sent to the parallel rule selector 714. For each of the input streams, if there is a match between the test input value and the current input value, and there is a match between the test current state and the current state (i.e., the transition rule is a match and a pattern is detected in the input stream), then the next state information in the retrieved transition rule is utilized to update the current state of the state machine. The next state information includes the next state 210, the next table address 212, the next mask 214 and the result flag 216 (which will be set to indicate that the transition rule is a match). As depicted in FIG. 7, the updating the current state of the state machine 716 includes updating the data in the current state vector and the mask vector.

In an exemplary embodiment, parallel lookup 708 of the default transition rules associated with each input stream is performed at the same time as the address generation 706 and parallel lookup 718 of the transition rules associated with each of the input values in the input vector 704. In an exemplary embodiment, the default transition rule table is stored in two groups of vector registers as depicted in FIG. 6, and a default transition rule associated with each of the input streams is retrieved at the same time (in parallel) as the transition rules associated with the other input streams are being retrieved. The results of the parallel lookup 708 are stored in a next state/table address vector and a mask vector and input to the parallel rule selector 714. For each of the input streams, if there was not a match between the test input value and the current input value, and/or there is not a match between the test current state and the current state (i.e., the transition rule is not a match and a pattern has not been detected in the input stream), then the next state information in the retrieved default transition rule is utilized to update the current state of the state machine. The next state information includes the next state 210, the next table address 212, the next mask 214 and the result flag 216 (which will be set to indicate that the transition rule is not a match). As depicted in FIG. 7, the updating the current state of the state machine 716 includes updating the data in the current state vector and the mask vector.

An exemplary embodiment implements sixteen B-FSMs that operate on sixteen independent input streams, and scan these against one set of patterns that are mapped on two transition rule tables and one default transition rule table, comprising a total of 384 transition rules stored in the SPE register set. By using eight SPEs in a CELL processor, a total of 128 streams can be scanned in parallel against patterns that can be mapped on sixteen transition rule tables and eight default rule tables, comprising a total of 3,000 transition rules (with each group of sixteen streams being scanned against the same set of two transition rule tables and one default transition rule table).

In one embodiment, each SPE operates on a different input stream. In another embodiment, the total number of patterns is increased by distributing the patterns over multiple SPEs by dividing the patterns into smaller subsets that are assigned to different SPEs, and by having these multiple SPEs operate on the same group of sixteen input streams. Combinations between these two embodiments may be implemented to balance the total number of patterns and aggregate processing rate.

Technical effects and benefits include providing a full vectorization of all pattern matching processing steps, including the memory accesses, in a parallel B-FSM implementation. This will allow a higher utilization of available execution units and thus, an increased scan rate.

The capabilities of some embodiments disclosed herein can be implemented in software, firmware, hardware or some combination thereof. As one example, one or more aspects of the embodiments disclosed can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the disclosed embodiments can be provided.

The diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention.

What is claimed is:

1. A method of pattern matching in a data processing system, the method comprising:
performing in parallel for a plurality of input streams:
calculating a memory address in a translation table responsive to a current input value, a current state and current state information;
retrieving a transition rule from the transition rule table at the memory address, the transition rule including a test input value, a test current state, and next state information;
determining if the current input value and the current state match the test input value and the test current state;
updating the current state information with the next state information in response to determining that the current input value and the current state match the test input value and the test current state; and
updating the current state information with contents of a default transition rule in response to determining that the current input value and the current state do not match the test input value and the test current state.

2. The method of claim 1 wherein the transition rule is located in a transition rule table and the current state information includes a table address for the start of the transition rule table.

3. The method of claim 1 wherein the current state information includes a mask for selecting the transition rule from a plurality of transition rules located at the memory address.

4. The method of claim 1 wherein the next state information includes a next state table address, a next state, a next state mask and a result flag.

5. The method of claim 1 wherein the transition rule is located in a transition rule table that spans a plurality of vector registers.

6. The method of claim 5 wherein the test input value for the transition rule is located in a different vector register than the test current state for the transition rule.

7. The method of claim 1 wherein the input streams are received from a plurality of state machines operating in parallel.

8. The method of claim 1 wherein the default transition rule is located in a default transition rule table that spans a plurality of vector registers.

9. A system for pattern matching, the system comprising:
a transition rule table for storing transition rules;
a plurality of state registers storing current states of a plurality of state machines;
an address generator including circuitry for receiving input current input values and for generating addresses corresponding to transition rules in response to the current input values and the current states;
a mechanism operating in parallel on multiple generated addresses for retrieving transition rules corresponding to each of the generated addresses, the retrieving from the transition rule table; and
a rule selector for updating the current states in response to the retrieved transition rules.

10. The system of claim 9 wherein the address generator further includes circuitry for receiving a current table address and a mask and the generating addresses is further responsive to the current table address and the mask.

11. The system of claim 9 further comprising a plurality of vector registers, wherein the transition rule table is stored in the vector registers.

12. The system of claim 11 wherein each transition rule includes a plurality of data fields, and two or more of the data fields for a transition rule are stored in different vector registers.

13. The system of claim 9 further comprising a default rule table for storing default transition rules, wherein the mechanism further retrieves default transition rules from the default rule table in response to the current input values and the current states, and the updating the current states is further responsive to the retrieved default transition rules.

14. A computer program product for pattern matching in a data processing system, the computer program product comprising:
a tangible storage medium readable by a processing circuit and storing instructions for execution by the processing circuit for performing a method comprising:
performing in parallel for a plurality of input streams:
calculating a memory address in a transition rule table responsive to a current input value, a current state and current state information;
retrieving a transition rule from the transition rule table at the memory address, the transition rule including a test input value, a test current state, and next state information;
determining if the current input value and the current state match the test input value and the test current state;
updating the current state information with the next state information in response to determining that the current input value and the current state match the test input value and the test current state; and
updating the current state information with contents of a default transition rule in response to determining that the current input value and the current state do not match the test input value and the test current state.

15. The computer program product of claim 14 wherein the transition rule is located in a transition rule table and the current state information includes a table address for the start of the transition rule table.

16. The computer program product of claim 14 wherein the current state information includes a mask for selecting the transition rule from a plurality of transition rules located at the memory address.

17. The computer program product of claim 14 wherein the next state information includes a next state table address, a next state, a next state mask and a result flag.

18. The computer program product of claim 14 wherein the transition rule is located in a transition rule table that spans a plurality of vector registers.

19. The computer program product of claim 18 wherein the test input value for the transition rule is located in a different vector register than the test current state for the transition rule.

20. The computer program product of claim 14 wherein the input streams are received from a plurality of state machines operating in parallel.
